(19) United States
(12) Patent Application Publication
(10) Pub. No.: US 2021/0400668 A1
(43) Pub. Date: Dec. 23, 2021

(54) USER TERMINAL AND RADIO COMMUNICATION METHOD

(71) Applicant: NTT DOCOMO, INC., Tokyo (JP)

(72) Inventors: Yuki Matsumura, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 17/292,106

(22) PCT Filed: Nov. 8, 2018
(86) PCT No.: PCT/JP2018/041537

§ 371 Date: May 7, 2021

(51) Int. Cl. H04W 72/04; H04W 72/02

(52) U.S. Cl. CPC H04W 72/0453; H04W 72/02

(57) ABSTRACT

A user terminal according to one aspect of the present disclosure includes:

a control section that, when a plurality of uplink channels is transmitted in an overlapping period, determines an uplink channel to be transmitted among the plurality of uplink channels based on information regarding quasi-co-location (QCL) of each of the plurality of uplink channels; and

a transmitting section that transmits the determined uplink channel in the period. According to one aspect of the present disclosure, it is possible to appropriately address simultaneous transmission of a plurality of uplink channels.

### TECHNICAL FIELD

The present disclosure relates to user terminal and a radio communication method in a next-generation mobile communication system.

### BACKGROUND ART

In a universal mobile telecommunications system (UMTS) network, long term evolution (LTE) has been specified for the purpose of, for example, a further high-speed data rate and a low delay (Non Patent Literature 1). LTE-Advanced (3GPP Re1.10-14) has been specified for the purpose of larger capacity and sophistication of LTE (3GPP (third generation partnership project) Rel. (Release) 8, 9).

Successor systems to LTE (e.g., also referred to as 5th generation mobile communication system (5G), 5G+ (plus), new radio (NR), and 3GPP Rel. 15 or later) are also studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In a future radio communication system (e.g., NR), it is studied that UE simultaneously transmits a plurality of channels with the same symbol in one or a plurality of component carriers (CCs). In NR, usage of beam forming is studied.

UE that uses analog beamforming, however, can form only one beam at certain timing. It has not been sufficiently studied which channel is to be transmitted in the case of simultaneous transmission of a plurality of channels. If transmission is not controlled in accordance with appropriate rules in simultaneous transmission of a plurality of channels, a discrepancy may occur between a base station and UE, which may cause a problem such as decrease of communication throughput.

One of objects of the present disclosure is to provide a user terminal and a radio communication method that can appropriately address simultaneous transmission of a plurality of uplink channels.

### Solution to Problem

A user terminal according to one aspect of the present disclosure includes:

a control section that, when a plurality of uplink channels is transmitted in an overlapping period, determines an uplink channel to be transmitted among the plurality of uplink channels based on information regarding quasi-co-location (QCL) of each of the plurality of uplink channels; and

a transmitting section that transmits the determined uplink channel in the period.

### Advantageous Effects of Invention

According to one aspect of the present disclosure, it is possible to appropriately address simultaneous transmission of a plurality of uplink channels.

### BRIEF DESCRIPTION OF DRAWINGS

FIG. 1 illustrates one example of a problem related to simultaneous transmission of a plurality of channels.

FIG. 2 illustrates one example of a schematic configuration of a radio communication system according to one embodiment.

FIG. 3 illustrates one example of the configuration of a base station according to one embodiment.

FIG. 4 illustrates one example of the configuration of user terminal according to one embodiment.

FIG. 5 illustrates one example of the hardware configuration of the base station and the user terminal according to one embodiment.

### DESCRIPTION OF EMBODIMENTS

(QCL/TCI)

In NR, it has been studied to control reception processing (e.g., at least one of reception, demapping, demodulation, and decoding) of at least one of a signal and a channel (expressed as a signal/channel) based on a transmission configuration indication state (TCI state).

Here, the TCI state is information regarding quasi-co-location (QCL) of the signal/channel, and may also be referred to as, for example, a spatial Rx parameter and spatial relation info. The TCI state may be set in UE for each channel or each signal.

QCL is an indicator indicating a statistical property of a signal/channel. For example, it may mean that, if one signal/channel has a QCL relation with another signal/channel, it can be assumed that these different multiple signals/channels are the same in at least one of Doppler shift, Doppler spread, average delay, delay spread, and a spatial parameter (e.g., a spatial reception (Rx) parameter) (are QCL in at least one of these elements).

Note that the spatial Rx parameter may correspond to a reception beam of UE (e.g., reception analog beam), and the beam may be identified based on spatial QCL. QCL (or at least one element of QCL) in the present disclosure may be replaced with spatial QCL (sQCL).

A plurality of types of QCL (QCL types) may be specified. For example, four QCL types A to D with different parameters (or parameter sets) that can be assumed to be identical may be provided. These parameters are as follows:

QCL type A: Doppler shift, Doppler spread, average delay, and delay spread;

QCL Type B: Doppler shift and Doppler spread;

QCL type C: Doppler shift and average delay; and

QCL type D: spatial Rx parameter.

It may be referred to as QCL assumption for UE to assume that a predetermined (given) CORESET, channel, or reference signal has a specific QCL (e.g., QCL type D) relation with another CORESET, channel, or reference signal.

UE may determine at least one of a transmission beam (Tx beam) and a reception beam (Rx beam) of a signal/channel based on a TCI state of the signal/channel or the QCL assumption.

The TCI state may be, for example, information regarding QCL of a target channel (or a reference signal (RS) for the channel) and another signal (e.g., another downlink reference signal (DL-RS). The TCI state may be configured (indicated) by higher layer signaling, physical layer signaling, or a combination thereof.

In the present disclosure, the higher layer signaling may be, for example, any of radio resource control (RRC) signaling, medium access control (MAC) signaling, broadcast information, and the like, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), and other system information (OSI).

The physical layer signaling may be, for example, downlink control information (DCI).

A channel for which a TCI state is configured (specified) may be, for example, at least one of a physical downlink shared channel (PDSCH), a physical downlink control channel (PDCCH), a physical uplink shared channel (PUSCH), and a physical uplink control channel (PUCCH).

RS having a QCL relation with the channel may be, for example, at least one of a synchronization signal block (SSB), a channel state information reference signal (CSI-RS), and a sounding reference signal (SRS).

SSB is a signal block including at least one of a primary synchronization signal (PSS), a secondary synchronization signal (SSS), and a physical broadcast channel (PBCH). SSB may be referred to as an SS/PBCH block.

An information element in a TCI state configured by higher layer signaling (“TCI state IE” of RRC) may include one or a plurality of pieces of QCL information (“QCL-Info”). The QCL information may include at least one piece of information regarding DL-RS having a QCL relation (DL-RS related information) and information indicating a QCL type (QCL type information). The DL-RS related information may include information such as an index of a DL-RS (e.g., SSB index or non-zero power CSI-RS resource ID), an index of a cell where an RS is positioned, and an index of a bandwidth part (BWP) where the RS is positioned.

(SRS)

In the NR, a sounding reference signal (SRS) has a wide range of usages. SRS in NR is used not only for CSI measurement of UL used in existing LTE (LTE Rel. 8 to 14), but for CSI measurement of DL, beam management, and the like.

One or a plurality of SRS resources may be configured in UE. The SRS resources may be identified by an SRS resource index (SRI).

Each SRS resource may include one or a plurality of SRS ports (may correspond to one or a plurality of SRS ports). For example, one, two, four, or the like of ports may be provided for each SRS.

One or a plurality of SRS resource sets may be configured in UE. One SRS resource set may be associated with a given number of SRS resources. UE may commonly use a higher layer parameter for the SRS resources included in one SRS resource set. Note that, in the present disclosure, the resource set may be replaced with a resource group, simply a group, and the like.

Information regarding the SRS resource set and/or SRS resources may be configured in UE by using higher layer signaling, physical layer signaling, or a combination thereof. Here, the higher layer signaling may be, for example, any of radio resource control (RRC) signaling, medium access control (MAC) signaling, broadcast information and the like, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), and other system information (OSI).

The physical layer signaling may be, for example, downlink control information (DCI).

SRS configuration information (e.g., “SRS-Config” of RRC information element) may include SRS resource set configuration information, SRS resource configuration information, and the like.

The SRS resource set configuration information (e.g., “SRS-ResourceSet” of RRC parameter) may include information on an SRS resource set identifier (ID) (SRS-ResourceSetId), a list of SRS resource IDs (SRS-ResourceId) used in the resource set, an SRS resource type, and SRS usage.

Here, the SRS resource type may indicate any of a periodic SRS (P-SRS), a semi-persistent SRS (SP-SRS), and an aperiodic CSI (Aperiodic SRS (A-SRS)). Note that UE may transmit P-SRS and SP-SRS periodically (or periodically after activated), and transmit A-SRS based on an SRS request in DCI.

The SRS usage (“usage” of RRC parameter and “SRS-SetUse” of Layer-1 (L1) parameter) may be, for example, beam management, codebook, non-codebook, and antenna switching. SRS used for the codebook or the non-codebook may be used to determine a precoder for codebook-based or non-codebook-based PUSCH transmission based on SRI.

For SRS used for beam management, it may be assumed that only one SRS resource per SRS resource set can be transmitted at a given time instant. Note that, when a plurality of SRS resources belong to different SRS resource sets, these SRS resources may be transmitted at the same time.

The SRS resource configuration information (e.g., “SRS-Resource” of RRC parameter) may include an SRS resource ID (SRS-ResourceId), the number of SRS ports, an SRS port number, transmission Comb, SRS resource mapping (e.g., time and/or frequency resource position, resource offset, resource periodicity, the number of repetitions, the number of SRS symbols, and SRS bandwidth), hopping related information, an SRS resource type, a sequence ID, and spatial relation information.

UE may transmit SRS in adjacent symbols of the number of SRS symbols out of last six symbols in one slot. Note that one, two, four, or the like of SRS symbols may be provided.

UE may switch a bandwidth part (BWP) to transmit SRS for each slot, or may switch an antenna. UE may apply at least one of intra-slot hopping and inter-slot hopping to SRS transmission.

Interleaved frequency-division multiple access (IFDMA) using Comb 2 (in which SRS is disposed every two resource elements (two REs)) or Comb 4 (in which SRS is disposed every four REs) and a cyclic shift (CS) may be applied as SRS transmission comb.

The SRS spatial relation information (“spatialRelationInfo” of RRC parameter) may indicate spatial relation information between a given reference signal and SRS. The given reference signal may be at least one of a synchronization signal/broadcast channel (synchronization signal/physical broadcast channel (SS/PBCH)) block, a channel state information reference signal (CSI-RS), and SRS (e.g., another SRS). Here, the SS/PBCH block may be referred to as a synchronous signal block (SSB).

The SRS spatial relation information may include at least one of an SSB index, a CSI-RS resource ID, and an SRS resource ID as an index of the given reference signal.

Note that, in the present disclosure, an SSB index, an SSB resource, and an SSB resource indicator (SSBRI) may be replaced with each other. The CSI-RS index, CSI-RS resource ID, and CSI-RS resource indicator (CRI) may be replaced with each other. An SRS index, an SRS resource ID, and SRI may be replaced with each other.

The SRS spatial relation information may include a serving cell index and a BWP index (BWP ID) corresponding to the above-described given reference signal.

When spatial relation information regarding SSB or CSI-RS and SRS is configured for certain SRS resources, UE may transmit the SRS resources by using the same spatial domain filter as a spatial domain filter for receiving the SSB or CSI-RS. That is, in this case, UE may assume that a UE reception beam of SSB or CSI-RS is the same as a UE transmission beam of SRS.

When spatial relation information regarding certain SRS (target SRS) and another SRS (reference SRS) is configured for the certain SRS (target SRS) resources, UE may transmit target SRS resources by using the same spatial domain filter as a spatial domain filter for transmitting the reference SRS. That is, in this case, UE may assume that a UE transmission beam of the reference SRS is the same as a UE transmission beam of the target SRS.

Note that a spatial domain filter for transmission of a base station, a downlink spatial domain transmission filter, and a transmission beam of the base station may be replaced with each other. The spatial domain filter for reception of the base station, the uplink spatial domain receive filter, and the reception beam of the base station may be replaced with each other.

A spatial domain filter for transmission of UE, an uplink spatial domain transmission filter, and a transmission beam of UE may be replaced with each other. The spatial domain filter for reception of UE, the downlink spatial domain receive filter, and the reception beam of UE may be replaced with each other.

A beam instruction for PUCCH may be configured by higher layer signaling (PUCCH-spatial-relation-info of RRC). For example, when the PUCCH-spatial-relation-info includes one spatial relation info (SpatialRelationInfo) parameter, UE may apply the set parameter to PUCCH. When the PUCCH-spatial-relation-info includes more than one spatial-relation-info parameter, a parameter to be applied to PUCCH (activated) may be determined based on a MAC CE.

Note that the spatial relation information of PUCCH may be obtained by replacing SRS with PUCCH in the spatial relationship information of SRS described above, so that the description will not be repeated.

A beam instruction for PUSCH may be determined based on an SRS resource indicator (SRI) field included in DCI. UE may transmit PUSCH by using the same transmission beam as a corresponding SRS among the SRS set in the higher layer based on the specified SRI.

(UL Simultaneous Transmission)

In NR, it is studied that UE simultaneously transmits a plurality of channels with the same symbol in one or a plurality of component carriers (CCs).

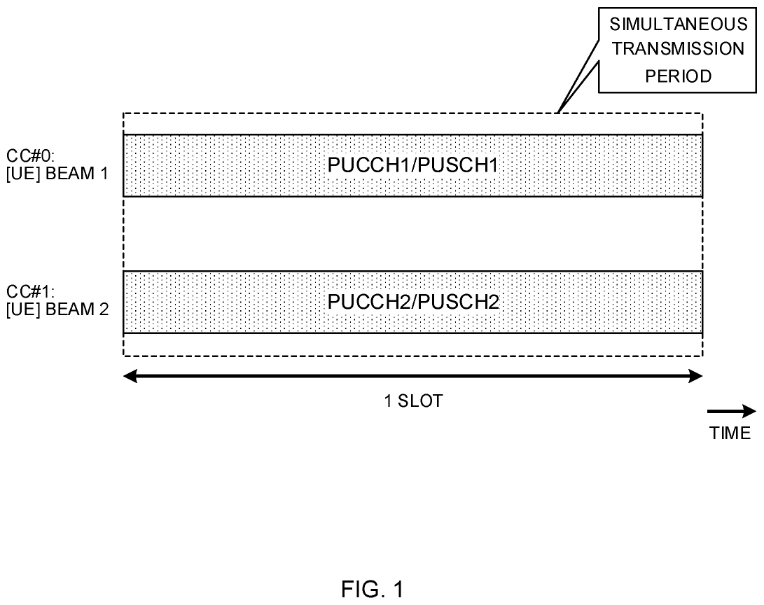

FIG. 1 illustrates one example of a problem related to simultaneous transmission of a plurality of channels. This example illustrates that UE transmits a channel (e.g., at least one of PUCCH and PUSCH) using different beams at two CCs in one slot. UE plans to transmit PUCCH1 or PUSCH1 by using a beam 1 in CC#0 and PUCCH2 or PUSCH2 by using a beam 2 in CC#1.

In NR, it has not been sufficiently studied which channel is to be transmitted in the case of simultaneous transmission of a plurality of channels as in FIG. 1. If transmission is not controlled in accordance with appropriate rules in simultaneous transmission of a plurality of channels, a discrepancy may occur between a base station and UE, which may cause a problem such as decrease of communication throughput.

The present inventors have conceived UE operation that can appropriately address simultaneous transmission of a plurality of uplink channels (for example, PUSCH-PUSCH).

Hereinafter, embodiments according to the present disclosure will be described in detail with reference to the drawings. The radio communication method according to each embodiment may be applied individually or in combination.

Hereinafter, SRI can be replaced with any of spatial relation information (or ID of spatial relation information) and an SRS resource index. For example, SRI for PUCCH may be replaced with the spatial relationship information (or ID (e.g., “PUCCH-SpatialRelationInfoId” of RRC parameter) of spatial relationship information), and the SRI for PUSCH may be replaced with the SRS resource index. SRI may be referred to as information regarding QCL.

In the present disclosure, the fact that a plurality of SRIs is the same may simply mean that the values of these SRIs are the same, and that the resources (e.g., SSB resources, CSI-RS resources, and SRS resources) corresponding to SRIs are the same. The same applies when the “same” is replaced with “different”.

The fact that a plurality of SRIs is the same may simply mean that the values of these SRIs are the same, and that the resources (e.g., SSB resources, CSI-RS resources, and SRS resources) corresponding to SRIs are the same. The same applies when the “same” is replaced with “different”.

Although, in the following embodiment, the cases where a plurality of simultaneously transmitted channels (first channel and second channel) is both PUCCHs, both PUSCH, and one PUCCH and the other PUSCH are described as premises, simultaneously transmitted signals and channels are not limited thereto. The channel of each embodiment may be replaced with SRS, a demodulation reference signal (DMRS), and the like.

(Radio Communication Method)

### First Embodiment

A first embodiment relates to an assumption at the time when a first channel and a second channel are simultaneously transmitted. The first embodiment is classified roughly into a case (Embodiment 1.1) where both SRIs of the two channels address UL RS (e.g., SRS) resources, a case (Embodiment 1.2) where both the SRIs address DL RS (e.g., CSI-RS and SSB) resources, and a case (Embodiment 1.3) where one SRI addresses UL RS resources and the other addresses DL RS resources.

### Embodiment 1.1

In Embodiment 1.1, when SRIs for two channels to be simultaneously transmitted are the same, UE may simultaneously transmit both the channels.

In Embodiment 1.1, when SRIs for two channels to be simultaneously transmitted are different, UE may determine to transmit a channel corresponding to any of the following (1) to (8) among the two channels during a simultaneous transmission period:

(1) Channel in CC of specific CC index (or serving cell index or secondary cell (SCell) index);

(2) Channel corresponding to specific SRI;

(3) Channel which is scheduled (or triggered) by DCI transmitted earliest or latest;

(4) Channel with longest or shortest duration;

(5) Channel including HARQ-ACK which corresponding PDSCH transmitted earliest or latest;

(6) Channel including higher priority uplink control information (UCI) (especially in the case where above-described two channels are both PUCCHs);

(7) PUCCH; and

(8) PUSCH.

Here, the “specific” in the above (1) and (2) may mean at least one of “lowest” “highest/largest”, and the like.

DCI of the above (3) may be DCI that schedules PDSCH (e.g., DL assignment), or DCI that schedules PUSCH (e.g., UL grant). For example, when the channel of the above (3) is PUCCH, DCI that schedules the channel may be DL assignment. When the channel of the above (3) is PUSCH, DCI that schedules the channel may be UL grant.

The priority of the above (6) may be higher in the order of HARQ-ACK, SR, and CSI (HARQ-ACK is the highest), for example. The priority in the case where a plurality of CSIs is provided may follow an existing CSI priority rule (which may be referred to as a dropping rule). Note that the priority of the above (6) is not limited thereto.

The above (5) and (6) may be applied particularly to the case where the above-described two channels are both PUCCHs. The above (7) and (8) may be applied particularly to the case where the above-described two channels are PUCCH and PUSCH.

According to the configuration in which UE transmits a channel with the smallest CC index in accordance with the above (1), the channel of an important primary cell (PCell) can be appropriately transmitted.

According to the configuration in which UE transmits a channel with the smallest SRI in accordance with the above (2), UE can secure communication of a specific beam by associating a beam, whose transmission is not desired to be dropped, with smaller SRI.

According to the configuration in which UE transmits a channel to which DCI scheduled in accordance with the above (3) is transmitted fastest, a channel that is likely to be ready for transmission can be transmitted. According to the configuration in which UE transmits a channel to which DCI scheduled in accordance with the above (3) is transmitted latest, a channel that is assumed to be more important can be appropriately transmitted.

According to the configuration in which UE transmits a channel having the longest or shortest duration in accordance with the above (4), UE can prioritize appropriate communication among low-delay communication, high-speed communication, and the like.

According to the configuration in which UE transmits a channel, including HARQ-ACK, to which corresponding PDSCH is transmitted fastest in accordance with the above (5), a channel in which HARQ-ACK is likely to be ready for transmission can be transmitted. According to the configuration in which UE transmits a channel, including HARQ-ACK, to which corresponding PDSCH is transmitted latest in accordance with the above (5), a channel assumed to be more important can be transmitted.

According to the above (6), a channel including UCI assumed to be more important can be appropriately transmitted.

According to the above (7) or (8), a specific channel can be appropriately transmitted at the time of simultaneous transmission.

Note that UE is not required to expect a case where SRIs for two channels to be simultaneously transmitted are different (UE may assume that such a case does not occur or that simultaneous transmission of channels with different SRIs is not scheduled).

### Embodiment 1.2

In Embodiment 1.2, when SRIs for two channels to be simultaneously transmitted are the same, UE may simultaneously transmit both the channels.

In Embodiment 1.2, when SRIs for two channels to be simultaneously transmitted are different, and a plurality of resources corresponding to these SRIs is of QCL type D (which may be referred to as QCL-D), UE may simultaneously transmit both the channels.

Note that the fact that the SSB resource and the CSI-RS resource are QCL-D may be determined based on, for example, an SSB index included in an RRC parameter “associatedSSB” set for the CSI-RS index.

In Embodiment 1.2, when SRIs for two channels to be simultaneously transmitted are different, and a plurality of resources corresponding to these SRIs is not QCL-D, UE may determine to transmit a channel corresponding to any of the above-described (1) to (8) among the two channels during the simultaneous transmission period. In Embodiments 1.1 and 1.2, different policies of the above-described (1) to (8) are preferably adopted.

Note that UE is not required to expect a case where SRIs for two channels to be simultaneously transmitted are different (UE may assume that such a case does not occur or that simultaneous transmission of channels with different SRIs is not scheduled).

### Embodiment 1.3

Embodiment 1.3 may be the same as Embodiment 1.1 or 1.2, so that the description will not be repeated.

According to the first embodiment described above, it is possible to appropriately address simultaneous transmission of a plurality of uplink channels.

### Second Embodiment

A second embodiment relates to UE capability. UE having specific UE capability or UE that has reported information on the specific UE capability may be assumed to successfully transmit a plurality of channels (particularly, plurality of channels having different corresponding SRIs) simultaneously. In contrast, UE not having specific UE capability or UE that has not reported information on the specific UE capability may be assumed to fail to simultaneously transmit a plurality of channels.

The above-described specific UE capability information may indicate that a plurality of channels can be simultaneously transmitted, may indicate that a multi-panel (e.g., UL multi-panel) is provided (supported), or may indicate that two or more transmission beams (or SRS resources or SRI) can be simultaneously transmitted (e.g., may indicate the maximum beam number, SRS number, or SRI number that can be simultaneously transmitted).

UE, which has reported the maximum number of beams capable of being simultaneously transmitted, may be restricted to simultaneously transmit channels up to the maximum number of beams at the timing of simultaneously transmitting channels larger in number than the maximum number of beams. If restricted, a channel to be transmitted may be determined as illustrated in the above-described first embodiment.

According to the second embodiment described above, it is possible to appropriately determine whether a plurality of uplink channels can be simultaneously transmitted.

<Variations>

In each embodiment described above, when more than two channels are simultaneously transmitted, a set of channels having a QCL-D relation with each other among these more than two channels may be simultaneously transmitted.

When more than two channels are simultaneously transmitted, and these channels include a set of first channels having the QCL-D relation with each other and a set of second channels having the QCL-D relation with each other, UE may simultaneously transmit a set having a larger number of channels among these sets.

For example, when SRI of PUCCH1 and SRI of PUCCH4 are different, PUCCHs 1 and 2 are of QCL-D, PUCCH3, 4, and 5 are QCL-D at the timing of simultaneously transmitting five PUCCHs (PUCCH1 to PUCCH5), UE may simultaneously transmit PUCCHs 3, 4, and 5, and drop PUCCHs 1 and 2.

Channels having the QCL-D relation with each other may be counted as one as the number of transmission beams no matter how many channels are simultaneously transmitted.

Note that, in the present disclosure, “simultaneous” may be replaced with “overlapped”. Simultaneous transmission of a plurality of channels may include the case where the plurality of channels completely overlaps with each other at the same time length as in FIG. 1, and the case where the plurality of channels overlaps with each other in a part of time resources (e.g., symbol). When SRIs (QCLs) of a plurality of channels having at least an overlapped part of time domain resources are different, the embodiments of the present disclosure may be applied to determination of an uplink channel to be transmitted in the part of time domain resources.

The embodiments of the present disclosure may be applied regardless of which of an analog beam and a digital beam UE can use. It can be expected that, for example, the processing load of UE is reduced by unifying the processing.

Although, in each embodiment, the description is given assuming that a plurality of channels is simultaneously transmitted through different CCs, this is not a limitation. Each channel may be transmitted in a specific different control unit. The control unit may be, for example, any of CC, a CC group, a cell group, a PUCCH-group, a MAC entity, a frequency range (FR), a band, BWP, and the like or a combination thereof. The control unit may be simply referred to as a group.

Even when a plurality of channels is simultaneously transmitted through the same CC, the method of each embodiment is applicable.

Although, in each embodiment described above, an example in which QCL of a UL channel can be determined by SRI is mainly illustrated, this is not a limitation. “Same/different SRI” in each embodiment may be replaced with same/different QCL (or QCL assumption or TCI state)”.

“SRIs of two channels are the same” may be replaced with one beam of the two channels (or resources corresponding to SRIs of two channels) is included in or close to the other beam. “Two resources are QCL-D” may be replaced with one beam of two resources is included in or close to the other beam.

(Radio Communication System)

The configuration of a radio communication system according to one embodiment of the present disclosure will be described below. In the radio communication system, communication is performed by using one or a combination of the radio communication methods according to each embodiment of the present disclosure.

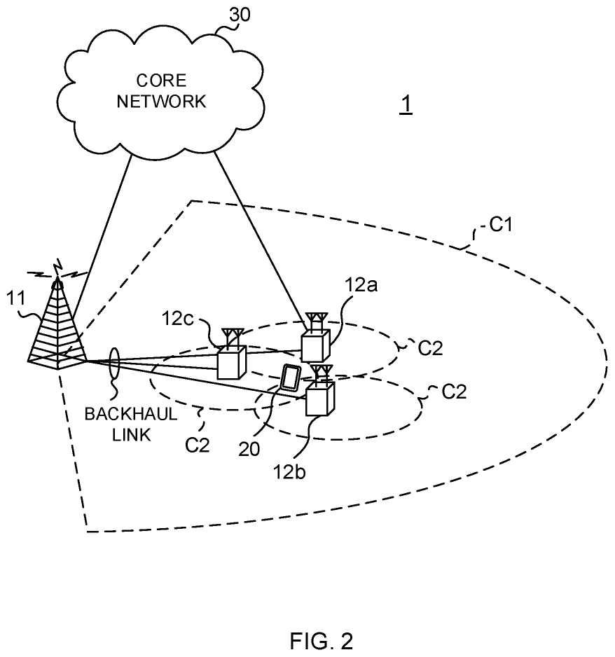

FIG. 2 illustrates one example of a schematic configuration of a radio communication system according to one embodiment. A radio communication system 1 may be a system that implements communication by using, for example, long term evolution (LTE) and 5th generation mobile communication system new radio (5G NR) specified by third generation partnership project (3GPP).

The radio communication system 1 may support dual connectivity (multi-RAT dual connectivity (MR-DC)) between a plurality of pieces of radio access technology (RAT). MR-DC may include dual connectivity between LTE (evolved universal terrestrial radio access (E-UTRA)) and NR (E-UTRA-NR dual connectivity (EN-DC)) and dual connectivity between NR and LTE (NR-E-UTRA dual connectivity (NE-DC)).

In EN-DC, an LTE (E-UTRA) base station (eNB) is a master node (MN), and an NR base station (gNB) is a secondary node (SN). In NE-DC, an NR base station (gNB) is MN, and an LTE (E-UTRA) base station (eNB) is SN.

The radio communication system 1 may support dual connectivity between a plurality of base stations in identical RAT (e.g., dual connectivity in which both MN and SN are NR base stations (gNBs) (NR-NR dual connectivity (NN-DC)).

The radio communication system 1 may include a base station 11 and base stations 12 (12a to 12c). The base station 11 forms a macro cell C1 with a relatively wide coverage. The base stations 12 (12a to 12c) are disposed within the macro cell C1, and form a small cell C2 narrower than the macro cel C1. User terminal 20 may be positioned in at least one cell. The arrangement, number, and the like of each cell and the user terminal 20 are not limited to the aspect illustrated in the figure. Hereinafter, the base stations 11 and 12 will be collectively referred to as “base stations 10”, unless these stations are distinguished from each other.

The user terminal 20 may be connected to at least one of the plurality of base stations 10. The user terminal 20 may use at least one of carrier aggregation using a plurality of component carriers (CCs) and dual connectivity (DC).

Each CC may be included in at least one of a frequency range 1 (FR1) and a frequency range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like of FR1 and FR2 are not limited to these, and, for example, FR1 may correspond to a frequency range higher than FR2.

The user terminal 20 may perform communication in each CC by using at least one of time division duplex (TDD) and frequency division duplex (FDD).

The plurality of base stations 10 may be connected by wire (e.g., optical fiber or X2 interface in compliance with common public radio interface (CPRI)) or by radio (e.g., NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include at least one of, for example, an evolved packet core (EPC), a 5G core network (5GCN), and a next generation core (NGC).

The user terminal 20 may support at least one of communication methods such as LTE, LTE-A, and 5G.

In the radio communication system 1, a radio access method based on orthogonal frequency division multiplexing (OFDM) may be used. For example, cyclic prefix OFDM (CP-OFDM), discrete Fourier transform spread OFDM (DFT-s-OFDM), orthogonal frequency division multiple access (OFDMA), single carrier frequency division multiple access (SC-FDMA) may be used in at least one of downlink (DL) and uplink (UL).

The radio access method may be referred to as a waveform. Note that, in the radio communication system 1, another radio access method (e.g., another single carrier transmission method and another multi-carrier transmission method) may be used as UL and DL radio access methods.

In the radio communication system 1, for example, a physical downlink shared channel (PDSCH) shared by each piece of the user terminal 20, a physical broadcast channel (PBCH), and a physical downlink control channel (PDCCH) may be used as a downlink channel.

In the radio communication system 1, for example, a physical uplink shared channel (PUSCH) shared by each piece of the user terminal 20, a physical uplink control channel (PUCCH), and a physical random access channel (PRACH) may be used as an uplink channel.

For example, user data, higher layer control information, and a system information block (SIB) are transmitted by PDSCH. PUSCH may transmit the user data, the higher layer control information, and the like. PBCH may transmit a master information block (MIB).

PDCCH may transmit lower layer control information. The lower layer control information may include, for example, downlink control information (DCI) including scheduling information of at least one of PDSCH and PUSCH.

Note that DCI that schedules PDSCH may be referred to as, for example, DL assignment and DL DCI, and DCI that schedules PUSCH may be referred to as, for example, UL grant and UL DCI. Note that PDSCH may be replaced with DL data, and PUSCH may be replaced with UL data.

A control resource set (CORESET) and search space may be used to detect PDCCH. CORESET corresponds to resources for searching for DCI. The search space corresponds to a search region and a search method for PDCCH candidates. One CORESET may be associated with one or a plurality of pieces of search space. UE may monitor CORESET associated with certain search space based on search space settings.

One SS may correspond to a PDCCH candidate corresponding to one or a plurality of aggregation levels. One or a plurality of pieces of search space may be referred to as a search space set. Note that, for example, “search space”, “search space set”, “search space settings”, “search space set settings”, “CORESET”, and “CORESET settings” in the present disclosure may be replaced with each other.

PUCCH may transmit channel state information (CSI), delivery confirmation information (e.g., hybrid automatic repeat request acknowledgement (HARQ-ACK), which may be referred to as ACK/NACK or the like), and scheduling request (SR). PRACH may transmit a random access preamble for establishing connection with a cell.

Note that, in the present disclosure, downlink, uplink, and the like may be expressed without “link”. Various channels may be expressed without adding “physical” at the beginning thereof.

In the radio communication system 1, for example, a synchronization signal (SS) and a downlink reference signal (DL-RS) may be transmitted. In the radio communication systems 1, for example, a cell-specific reference signal (CRS), a channel state information reference signal (CSI-RS), a demodulation reference signal (DMRS), a positioning reference signal (PRS), and a phase tracking reference signal (PTRS) may be transmitted as DL-RS.

The synchronization signal may be at least one of, for example, a primary synchronization signal (PSS) and a secondary synchronization signal (SSS). A signal block including SS (PSS or SSS) and PBCH (and DMRS for PBCH) may be referred to as, for example, an SS/PBCH block and an SS Block (SSB). Note that SS, SSB, and the like may also be referred to as a reference signal.

In the radio communication system 1, for example, a sounding reference signal (SRS) and a demodulation reference signal (DMRS) may be transmitted as an uplink reference signal (UL-RS). Note that, DMRS may be referred to as a user terminal-specific reference signal (UE-specific reference signal).”

(Base Station)

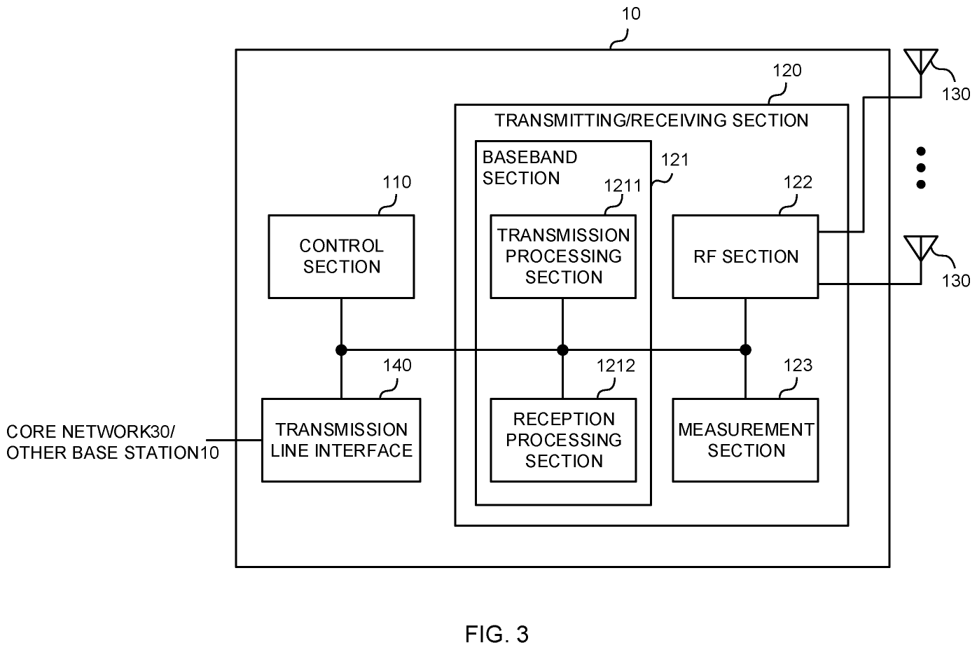

FIG. 3 illustrates one example of the configuration of a base station according to one embodiment. The base station 10 includes a control section 110, a transmitting/receiving section 120, a transmission/reception antenna 130, and a transmission line interface 140. Note that one or more of the control sections 110, one or more of the transmitting/receiving sections 120, one or more of the transmission/reception antennas 130, and one or more of the transmission line interfaces 140 may be provided.

Note that the example mainly illustrates a functional block of a characteristic part of the present embodiment. The base station 10 may be assumed to have another functional block necessary for radio communication as well. A part of processing of each unit described below may be omitted.

The control section 110 controls the entire base station 10. The control section 110 can include a controller and a control circuit, which is described based on common recognition in the technical field according to the present disclosure.

The control section 110 may control, for example, signal generation and scheduling (e.g., resource allocation or mapping). The control section 110 may control, for example, transmission/reception and measurement using the transmitting/receiving section 120, the transmission/reception antenna 130, and the transmission line interface 140. The control section 110 may generate, for example, data to be transmitted as a signal, control information, and a sequence, and transfer the data, the control information, and the sequence to the transmitting/receiving section 120. The control section 110 may perform, for example, call processing (e.g., settings and releasing) of a communication channel, management of the state of the base station 10, and management of radio resources.

The transmitting/receiving section 120 may include a baseband unit 121, a radio frequency (RF) unit 122, and a measurement unit 123. The baseband unit 121 may include a transmission processing unit 1211 and a reception processing unit 1212. The transmitting/receiving section 120 can include a transmitter/receiver, an RF circuit, a baseband circuit, a filter, a phase shifter, a measurement circuit, and a transmission/reception circuit, which are described based on common recognition in the technical field according to the present disclosure.

The transmitting/receiving section 120 may be configured as an integrated transmitting/receiving section, or may be configured by a transmitting section and a receiving section. The transmitting section may include the transmission processing unit 1211 and the RF unit 122. The receiving section may include the reception processing unit 1212, the RF unit 122, and the measurement unit 123.

The transmission/reception antenna 130 can include an antenna described based on common recognition in the technical field according to the present disclosure, for example, an array antenna.

The transmitting/receiving section 120 may transmit, for example, the above-described downlink channel, synchronization signal, and downlink reference signal. The transmitting/receiving section 120 may receive, for example, the above-described uplink channel and uplink reference signal.

The transmitting/receiving section 120 may form at least one of a transmission beam and a reception beam by using, for example, digital beam forming (e.g., precoding) and analog beam forming (e.g., phase rotation).

The transmitting/receiving section 120 (transmission processing unit 1211) may perform packet data convergence protocol (PDCP) layer processing, radio link control (RLC) layer processing (e.g., RLC retransmission control), and medium access control (MAC) layer processing (e.g., HARQ retransmission control), and the like on, for example, data and control information acquired from the control section 110 to generate a bit string to be transmitted.

The transmitting/receiving section 120 (transmission processing unit 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog transform on the bit string to be transmitted, and may output a baseband signal.

The transmitting/receiving section 120 (RF unit 122) may perform, for example, modulation to a radio frequency range, filtering processing, and amplification on a baseband signal, and transmit a signal in the radio frequency range via the transmission/reception antenna 130.

In contrast, the transmitting/receiving section 120 (RF unit 122) may perform, for example, amplification, filtering processing, and demodulation to a baseband signal on a signal in the radio frequency range received by the transmission/reception antenna 130.

The transmitting/receiving section 120 (reception processing unit 1212) may apply, on an acquired baseband signal, reception processing such as analog-digital transform, fast Fourier transform (FFT) processing, inverse discrete Fourier transform (IDFT) processing (if necessary), filtering processing, demapping, demodulation, decoding (which may include error correction decoding), MAC layer processing, RLC layer processing, and PDCP layer processing, and acquire user data.

The transmitting/receiving section 120 (measurement unit 123) may perform measurement on the received signal. For example, the measurement unit 123 may perform, for example, radio resource management (RRM) measurement and channel state information (CSI) measurement based on the received signal. The measurement unit 123 may measure, for example, received power (e.g., reference signal received power (RSRP)), received quality (e.g., reference signal received quality (RSRQ), signal to interference plus noise ratio (SINR), signal to noise ratio (SNR)), signal strength (e.g., received signal strength indicator (RSSI)), and propagation path information (e.g., CSI), and the like. The measurement result may be output to the control section 110.

The transmission line interface 140 may transmit/receive a signal (perform backhaul signaling) to and from an apparatus included in the core network 30, other base stations 10, and the like, and may, for example, acquire and transmit user data (user plane data), control plane data, and the like for the user terminal 20.

Note that the transmitting section and the receiving section of the base station 10 in the present disclosure may include at least one of the transmitting/receiving section 120, the transmission/reception antenna 130, and the transmission line interface 140.

Note that the control section 210 may schedule the user terminal 20 to transmit a plurality of uplink channels in an overlapping period (e.g., same OFDM symbol). The control section 210 may receive an uplink channel determined (selected) by the user terminal 20 based on information regarding the QCL of each of the plurality of uplink channels in the overlapping period.

(User terminal)

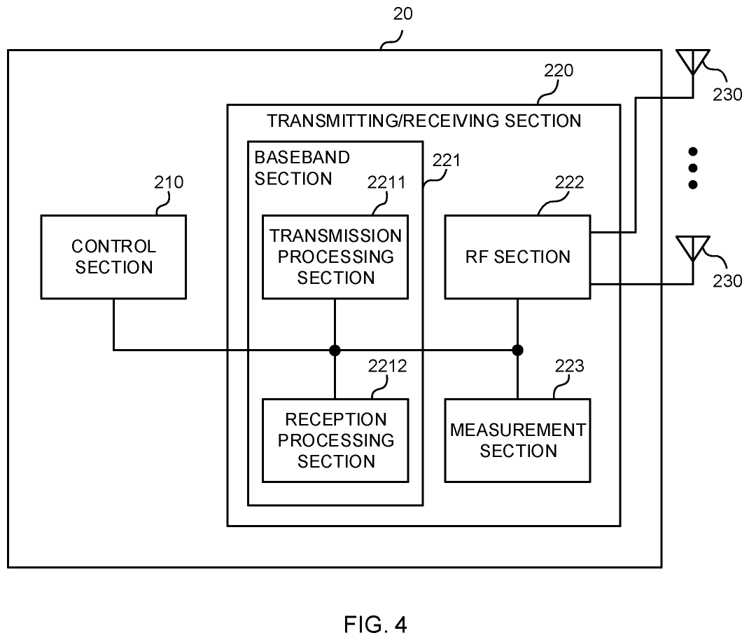

FIG. 4 illustrates one example of the configuration of user terminal according to one embodiment. The user terminal 20 includes a control section 210, a transmitting/receiving section 220, and a transmission/reception antenna 230. Note that one or more of the control sections 210, one or more of the transmitting/receiving sections 220, and one or more of the transmission/reception antennas 230 may be provided.

Note that the example mainly illustrates a functional block of a characteristic part of the present embodiment. The user terminal 20 may be assumed to have another functional block necessary for radio communication as well. A part of processing of each unit described below may be omitted.

The control section 210 controls the entire user terminal 20. The control section 210 can include a controller and a control circuit, which is described based on common recognition in the technical field according to the present disclosure.

The control section 210 may control, for example, signal generation and mapping. The control section 210 may control, for example, transmission/reception using the transmitting/receiving section 220 and the transmission/reception antenna 230 and measurement. The control section 210 may generate, for example, data to be transmitted as a signal, control information, and a sequence, and transfer the data, the control information, and the sequence to the transmitting/receiving section 220.

The transmitting/receiving section 220 may include a baseband unit 221, an RF unit 222, and a measurement unit 223. The baseband unit 221 may include a transmission processing unit 2211 and a reception processing unit 2212. The transmitting/receiving section 220 can include a transmitter/receiver, an RF circuit, a baseband circuit, a filter, a phase shifter, a measurement circuit, and a transmission/reception circuit, which are described based on common recognition in the technical field according to the present disclosure.

The transmitting/receiving section 220 may be configured by an integrated transmitting/receiving section, or may be configured by a transmitting section and a receiving section. The transmitting section may include the transmission processing unit 2211 and the RF unit 222. The receiving section may include the reception processing unit 2212, the RF unit 222, and the measurement unit 223.

The transmission/reception antenna 230 can include an antenna described based on common recognition in the technical field according to the present disclosure, for example, an array antenna.

The transmitting/receiving section 220 may receive, for example, the above-described downlink channel, synchronization signal, and downlink reference signal. The transmitting/receiving section 220 may transmit, for example, the above-described uplink channel and uplink reference signal.

The transmitting/receiving section 220 may form at least one of a transmission beam and a reception beam by using, for example, digital beam forming (e.g., precoding) and analog beam forming (e.g., phase rotation).

The transmitting/receiving section 220 (transmission processing unit 2211) may perform PDCP layer processing, RLC layer processing (e.g., RLC retransmission control), MAC layer processing (e.g., HARQ retransmission control), and the like on, for example, data acquired from the control section 210 and control information to generate a bit string to be transmitted.

The transmitting/receiving section 220 (transmission processing unit 2211) may perform, on a bit string to be transmitted, transmission processing such as channel encoding (which may include error correction encoding), modulation, mapping, filtering processing, DFT processing (if necessary), IFFT processing, precoding, and digital-analog transform, and output a baseband signal.

Note that whether or not to apply DFT processing may be determined based on settings of transform precoding. When transform precoding is enabled for a certain channel (e.g., PUSCH), the transmitting/receiving section 220 (transmission processing unit 2211) may perform DFT processing as the above-described transmission processing in order to transmit the channel by using a DFT-s-OFDM waveform. When this is not the case, the transmitting/receiving section 220 (transmission processing unit 2211) is not required to perform DFT processing as the above-described transmission processing.

The transmitting/receiving section 220 (RF unit 222) may perform, for example, modulation to a radio frequency range, filtering processing, and amplification on a baseband signal, and transmit a signal in the radio frequency range via the transmission/reception antenna 230.

In contrast, the transmitting/receiving section 220 (RF unit 222) may perform, for example, amplification, filtering processing, and demodulation to a baseband signal on the signal in the radio frequency range received by the transmission/reception antenna 230.

The transmitting/receiving section 220 (reception processing unit 2212) may apply, on an acquired baseband signal, reception processing such as analog-digital transform, FFT processing, IDFT processing (if necessary), filtering processing, demapping, demodulation, decoding (which may include error correction decoding), MAC layer processing, RLC layer processing, and PDCP layer processing, and acquire, for example, user data.

The transmitting/receiving section 220 (measurement unit 223) may perform measurement on the received signal. For example, the measurement unit 223 may perform, for example, RRM measurement and CSI measurement based on the received signal. The measurement unit 223 may measure, for example, received power (e.g., RSRP), received quality (e.g., RSRQ, SINR, and SNR), signal strength (e.g., RSSI), and propagation path information (e.g., CSI). The measurement result may be output to the control section 210.

Note that the transmitting section and the receiving section of the user terminal 20 in the present disclosure may include at least one of the transmitting/receiving section 220, the transmission/reception antenna 230, and the transmission line interface 240.

Note that, when transmission of a plurality of uplink channels (e.g., PUSCH and PUSCH, two PUCCHs, and two PUSCHs) is performed (which may mean that transmission is indicated (scheduled), is planned, and the like) in an overlapping period (e.g., same OFDM symbol), the control section 210 may determine an uplink channel to be transmitted among the plurality of uplink channels based on information regarding QCL of each of the plurality of uplink channels.

The information regarding QCL may be one of spatial relation information, an ID of the spatial relation information, an SRS resource index, information regarding SRS, a TCI state, and the like. The information regarding QCL may be transmitted by higher layer signaling, physical layer signaling, or a combination thereof.

The transmitting/receiving section 220 may transmit the above-described uplink channel determined by the control section 210 to the base station 10 in the overlapping period.

The control section 210 may determine to transmit a channel corresponding to any of (1)-(8) described in the first embodiment, for example. For example, when the pieces of information regarding the QCL of the plurality of uplink channels are different, the control section 210 may determine a channel having the longest or shortest duration among the plurality of uplink channels as an uplink channel to be transmitted.

When the number of a plurality of uplink channels is more than two, and the plurality of uplink channels includes a set of first uplink channels having a relation of QCL type D with each other and a set of second uplink channels having a relation of QCL type D with each other, the control section 210 may determine an uplink channel included in a set having a larger number of channels as an uplink channel to be transmitted. Note that the set may be referred to as a group.

When the plurality of uplink channels is larger in number than the maximum number of beams capable of being simultaneously transmitted, the control section 210 may determine an uplink channel to be transmitted among the plurality of uplink channels based on information regarding the QCL of the plurality of uplink channels. The transmitting/receiving section 220 may transmit capability information on the maximum number of beams capable of being simultaneously transmitted to the base station 10.

(Hardware Configuration)

Note that the block diagrams that have been used to describe the above-described embodiments indicate blocks in functional units. These functional blocks (configuration units) is implemented in any combination of at least one of hardware or software. The method of implementing each functional block is not particularly limited. That is, each functional block may be achieved by one apparatus physically or logically coupled, or may be achieved by directly or indirectly connecting two or more physically or logically separate apparatuses (e.g., using wires, radio, or the like) and using these plurality of apparatuses. The functional block may be achieved by combining the above-described one apparatus or the plurality of apparatuses with software.

Here, the functions include, but are not limited to, judging, determination, decision, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, and assigning. For example, a functional block (configuration unit) that causes transmission to function may be called as, for example, a transmitting unit and a transmitter. In any case, as described above, the implementation method is not particularly limited.

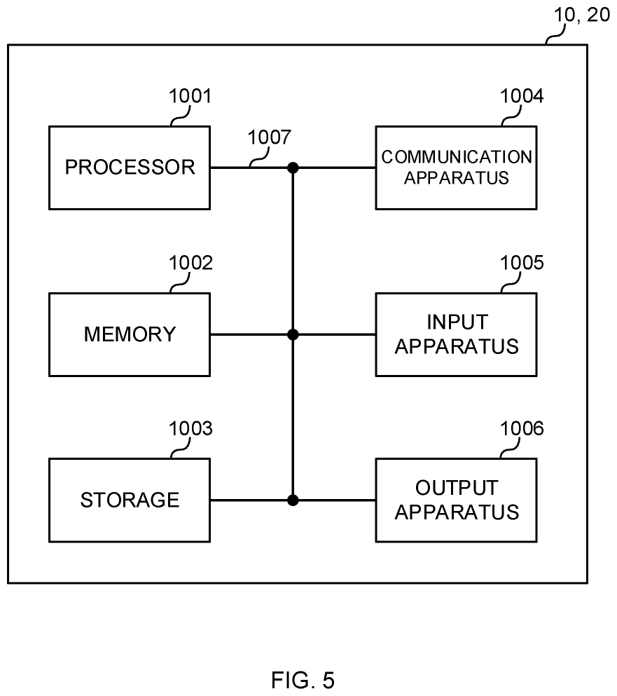

For example, the base station, the user terminal, and the like according to one embodiment of the present disclosure may function as a computer that performs the processing of the radio communication method of the present disclosure. FIG. 5 illustrates one example of the hardware configuration of a base station and a user terminal according to one embodiment. The above-described base station 10 and user terminal 20 may be physically formed as a computer apparatus including a processor 1001, a memory 1002, a storage 1003, a communication apparatus 1004, an input apparatus 1005, an output apparatus 1006, and a bus 1007.

Note that, in the present disclosure, the terms such as an apparatus, a circuit, a device, a section, and a unit can be replaced with each other. The hardware configuration of the base station 10 and the user terminal 20 may be configured to include one or a plurality of apparatuses illustrated in the figures, or may be configured without including some apparatuses.

For example, although only one processor 1001 is illustrated, a plurality of processors may be provided. One processor may execute processing, and two or more processors may execute the processing simultaneously, sequentially, or in another method. Note that the processor 1001 may be mounted with one or more chips.

Each function of the base station 10 and the user terminal 20 is implemented by, for example, controlling communication via the communication apparatus 1004 by causing predetermined software (program) to be read on hardware such as the processor 1001 and the memory 1002 and thereby causing the processor 1001 to perform operation, or by controlling at least one of reading and writing of data in the memory 1002 and the storage 1003.

The processor 1001 controls the entire computer by, for example, operating an operating system. The processor 1001 may include a central processing unit (CPU) including an interface with peripheral equipment, a control apparatus, an operation apparatus, and a register. For example, at least a part of the above-described control section 110 (210), transmitting/receiving section 120 (220), and the like may be implemented by the processor 1001.

The processor 1001 reads, for example, programs (program codes), software modules, and data from at least one of the storage 1003 and the communication apparatus 1004 to the memory 1002, and executes various pieces of processing in accordance with the programs (program codes), software modules, and data. A program to cause a computer to execute at least a part of the operations described in the above-described embodiment is used as the program. For example, the control section 110 (210) may be implemented by a control program that is stored in the memory 1002 and operates on the processor 1001. Other functional blocks may be similarly implemented.

The memory 1002 is a computer-readable recording medium, and may include at least one of, for example, a read only memory (ROM), an erasable programmable ROM (EPROM), an electrically EPROM (EEPROM), a random access memory (RAM) and other appropriate storage media. The memory 1002 may be referred to as a register, a cache, a main memory (primary storage apparatus), and the like. The memory 1002 can store a program (program code), a software module, and the like, which can be executed for performing the radio communication method according to one embodiment of the present disclosure.

The storage 1003 is a computer-readable recording medium, and may include at least one of, for example, a flexible disk, a floppy (registered trademark) disk, a magneto-optical disk (e.g., a compact disc ROM (CD-ROM)), a digital versatile disc, a Blu-ray (registered trademark) disk, a removable disk, a hard disk drive, a smart card, a flash memory device (e.g., card, stick, and key drive), a magnetic stripe, a database, a server, and other appropriate storage media. The storage 1003 may be referred to as an auxiliary storage apparatus.

The communication apparatus 1004 is hardware (transmission/reception device) for performing inter-computer communication via at least one of a wired network and a wireless network, and is referred to as, for example, a network device, a network controller, a network card, and communication module. The communication apparatus 1004 may include a high frequency switch, a duplexer, a filter, and a frequency synthesizer in order to achieve at least one of, for example, frequency division duplex (FDD) and time division duplex (TDD). For example, the communication apparatus 1004 may implement the above-described transmitting/receiving section 120 (220), transmission/reception antenna 130 (230), and communication apparatus 1004. The transmitting/receiving section 120 (220) may be mounted in a physically or logically separated manner with the transmission 120a (220a) and the receiving section 120b (220b).

The input apparatus 1005 is an input device (e.g., keyboard, mouse, microphone, switch, button, and sensor) for receiving input from the outside. The output apparatus 1006 is an output device (e.g., display, speaker, and light emitting diode (LED) lamp) for performing output to the outside. Note that the input apparatus 1005 and the output apparatus 1006 may be an integrated configuration (e.g., touch panel).

Apparatuses such as the processor 1001 and the memory 1002 are connected by the bus 1007 for communicating information. The bus 1007 may include a single bus, or may include buses different between the apparatuses.

The base station 10 and the user terminal 20 may include hardware such as a microprocessor, a digital signal processor (DSP), an application specific integrated circuit (ASIC), a programmable logic device (PLD), and a field programmable gate array (FPGA), and part or all of each functional block may be implemented by the hardware. For example, the processor 1001 may be mounted with at least one of these pieces of hardware.

(Variations)

Note that terms described in the present disclosure and terms necessary for understanding the present disclosure may be replaced with other terms that have the same or similar meanings. For example, a channel, a symbol, and a signal (or signaling) may be replaced with each other. The signal may be a message. A reference signal can be abbreviated as an “RS”, and may be referred to as a “pilot”, a “pilot signal” and the like, depending on a standard to be applied. A component carrier (CC) may be referred to as a cell, a frequency carrier, a carrier frequency, and the like.

The radio frame may include one or a plurality of periods (frames) in a time domain. Each of one or a plurality of periods (frames) constituting the radio frame may be referred to as a subframe. The subframe may include one or a plurality of slots in the time domain. The subframe may be a fixed time length (e.g., 1 ms) that does not depend on numerology.

Here, the numerology may be a communication parameter applied to at least one of transmission and reception of a certain signal or channel. The numerology may indicate at least one of, for example, subcarrier spacing (SCS), a bandwidth, a symbol length, a cyclic prefix length, a transmission time interval (TTI), the number of symbols per TTI, a radio frame configuration, specific filtering processing to be performed by a transceiver in the frequency domain, and specific windowing processing to be performed by the transceiver in the time domain.

The slot may include one or a plurality of symbols (e.g., orthogonal frequency division multiplexing (OFDM) symbols and single carrier frequency division multiple access (SC-FDMA) symbols) in the time domain. The slot may be a time unit based on numerology.

A slot may include a plurality of mini-slots. Each mini-slot may include one or a plurality of symbols in the time domain. The mini-slot may be referred to as a “sub-slot”. Each mini-slot may include symbols fewer in number than a slot. PDSCH (or PUSCH) transmitted in a time unit larger than a mini-slot may be referred to as PDSCH (PUSCH) mapping type A. PDSCH (or PUSCH) transmitted by using a mini-slot may be referred to as PDSCH (PUSCH) mapping type B.

All of the radio frame, the subframe, the slot, the mini-slot, and the symbol represents a time unit at the time of transmitting a signal. The radio frame, the subframe, the slot, the mini-slot, and the symbol may be called by other applicable names. Note that time units such as a frame, a subframe, a slot, a mini-slot, and a symbol in the present disclosure may be replaced with each other.

For example, one subframe may be referred to as TTI, a plurality of consecutive subframes may be referred to as TTI, and one slot or one mini-slot may be referred to as TTI. That is, at least one of the subframe and TTI may be a subframe (1 ms) in an existing LTE, may be a period shorter than 1 ms (e.g., 1-13 symbols), and may be a period longer than 1 ms. Note that the unit representing TTI may be referred to as a “slot”, a “mini-slot”, and the like, instead of a “subframe”.

Here, TTI refers to a minimum time unit of scheduling in radio communication, for example. For example, in LTE systems, the base station performs scheduling of allocating radio resources (such as frequency bandwidth and transmission power that can be used in each piece of user terminal) to each user terminal in TTI units. Note that the definition of TTI is not limited to this definition.

TTI may be a unit of time of transmitting a channel-encoded data packet (transport block), a code block, a codeword, and the like, or may be a processing unit for scheduling, link adaptation, and the like. Note that, when TTI is given, a time interval (e.g., the number of symbols) in which the transport block, the code block, the codeword, and the like are actually mapped may be shorter than the TTI.

Note that, when one slot or one mini-slot is referred to as TTI, one or more TTIs (i.e., one or more slots or one or more mini-slots) may be the minimum time unit of scheduling. The number of slots (the number of mini-slots) which constitute the minimum time unit of the scheduling may be controlled.

TTI having a time length of 1 ms may be referred to as, for example, usual TTI (TTI in 3GPP Rel. 8to 12), normal TTI, long TTI, a usual subframe, a normal subframe, a long subframe, and a slot. TTI shorter than the usual TTI may be referred to as, for example, shortened TTI, short TTI, partial TTI (or fractional TTI), a shortened subframe, a short subframe, a mini-slot, a sub-slot, and a slot.

Note that long TTI (e.g., usual TTI and subframe) may be replaced with TTI having a time length exceeding 1 ms, and short TTI (e.g., shortened TTI) may be replaced with TTI having a TTI length less than the TTI length of a long TTI and equal to or more than 1 ms.

A resource block (RB) is a resource allocation unit in the time domain and the frequency domain, and may include one or a plurality of consecutive subcarriers in the frequency domain. The number of subcarriers included in RB may be the same regardless of the numerology, and may be 12 for example. The number of subcarriers included in the RB may be determined based on the numerology.

RB may include one or a plurality of symbols in the time domain, and may be one slot, one mini-slot, one subframe, or one TTI in length. One TTI, one subframe, and the like each may include one or a plurality of resource blocks.

Note that one or a plurality of RBs may be referred to as, for example, physical resource blocks (physical RBs (PRBs)), sub-carrier groups (SCGs), resource element groups (REGs), a PRB pair, and an RB pair.

The resource block may include one or a plurality of resource elements (REs). For example, one RE may be a radio resource region of one subcarrier and one symbol.

A bandwidth part (BWP) (which may be called partial bandwidth and the like) may represent a subset of consecutive common resource blocks (RBs) for certain numerology in a certain carrier. Here, the common RB may be specified by the index of the RB based on a common reference point of the carrier. PRB may be defined in certain BWP and numbered within the BWP.

BWP may include BWP for UL (UL BWP) and BWP for DL (DL BWP). One or a plurality of BWPs may be set within one carrier for UE.

At least one of the set BWPs may be active, and UE is not required to assume to transmit or receive a predetermined signal/channel outside the active BWP. Note that “cell”, “carrier”, and the like in the present disclosure may be replaced with “BWP”.

Note that the configurations of the above-described radio frame, subframe, slot, mini-slot, and symbol are merely examples. For example, configurations such as the number of subframes included in a radio frame, the number of slots per subframe or radio frame, the number of mini-slots included in a slot, the number of symbols and RBs included in a slot or a mini-slot, the number of subcarriers included in RB, and the number of symbols, the symbol length, the cyclic prefix (CP) length in TTI can be variously changed.

Information, parameters, and the like described in the present disclosure may be represented by using an absolute value, may be represented by using a relative value from a predetermined value, or may be represented by using another piece of corresponding information. For example, radio resources may be indicated by a predetermined index.

The names used for parameters and the like in the present disclosure are in no respect limitative. Mathematical expressions and the like using these parameters may differ from those explicitly disclosed in the present disclosure. Since various channels (e.g., physical uplink control channel (PUCCH) and physical downlink control channel (PDCCH)) and information elements can be identified by all suitable names, the various names assigned to these various channels and information elements are in no respect limitative.

The information, signals, and the like described in the present disclosure may be represented by using any of various different pieces of technology. For example, data, instructions, commands, information, signals, bits, symbols, and chips, which may be referred to throughout the above description, may be represented by voltages, currents, electromagnetic waves, magnetic fields or magnetic particles, optical fields or photons, or any combination thereof.

Information, signals, and the like can be output at least one of from a higher layer to a lower layer and from a lower layer to a higher layer. Information, signals, and the like may be input/output via a plurality of network nodes.

The input/output information, signals, and the like may be stored in a specific location (e.g., memory), or may be managed by using a control table. The information, signals, and the like to be input/output can be overwritten, updated, or appended. The input/output information, signals, and the like may be deleted. The input/output information, signals, and the like may be transmitted to another apparatus.

Information may be reported not in the aspects/embodiments described in the present disclosure but by another method. For example, in the present disclosure, information may be reported by physical layer signaling (e.g., downlink control information (DCI) and uplink control information (UCI)), higher layer signaling (e.g., radio resource control (RRC) signaling, broadcast information (master information block (MIB), system information block (SIB), and the like), and medium access control (MAC) signaling), another signal, or a combination thereof.

Note that the physical layer signaling may be referred to as, for example, layer 1/layer 2 (L1/L2) control information (L1/L2 control signal) and L1 control information (L1 control signal). The RRC signaling may be referred to as an RRC message, and may be, for example, an RRC connection setup message, an RRC connection reconfiguration message, and the like. The MAC signaling may be reported by using, for example, a MAC control element (MAC CE).

Predetermined information may be reported (e.g., “being X” may be reported) not explicitly but implicitly (e.g., by no reporting the predetermined information or reporting another piece of information).

Judging may be performed by a value represented in one bit (0 or 1), may be performed in a Boolean value represented by true or false, or may be performed by comparing numerical values (e.g., comparison against a predetermined value).

Regardless of whether referred to as software, firmware, middleware, microcode, or hardware description language, or referred to by other names, software should be broadly interpreted to mean, for example, an instruction, an instruction set, a code, a code segment, a program code, a program, a subprogram, a software module, an application, a software application, a software package, a routine, a subroutine, an object, an executable file, an execution thread, a procedure, and a function.

Software, an instruction, information, and the like may be transmitted/received via a transmission medium. For example, when software is transmitted from a website, a server, or another remote source by using at least one of wired technology (e.g., coaxial cable, optical fiber cable, twisted-pair cable, and digital subscriber line (DSL)) and radio technology (e.g., infrared radiation and microwaves), at least one of the wired technology and radio technology is included in the definition of the transmission medium.

The terms “system” and “network” used in the present disclosure may be interchangeably used. The “network” may mean an apparatus (e.g., base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be interchangeably used.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier” may be interchangeably used. The base station may be referred to by a term such as a macro cell, a small cell, a femto cell, and a pico cell.

The base station can accommodate one or a plurality of (e.g., three) cells. When the base station accommodates a plurality of cells, the entire coverage area of the base station can be partitioned into a plurality of smaller areas, and each smaller area can provide communication service by a base station subsystem (e.g., indoor small base station (remote radio head (RRH))). A term “cell” or “sector” refers to all or part of the coverage area of at least one of a base station and a base station subsystem that provide communication service within the coverage.

In the present disclosure, terms such as “mobile station (MS)”, “user terminal”, “user equipment (UE)”, and “terminal” may be interchangeably used.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, and a client, or by some other suitable terms.

At least one of the base station or the mobile station may be referred to as, for example, a transmission apparatus, a reception apparatus, and a radio communication apparatus. Note that at least one of the base station and the mobile station may be, for example, a device mounted on a moving object and a moving object itself. The moving object may be a vehicle (e.g., car and airplane), an unmanned moving object (e.g., drone and autonomous car), or a (manned or unmanned) robot. Note that at least one of the base station or the mobile station also includes an apparatus that does not necessarily move during communication operation. For example, at least one of the base station and the mobile station may be internet of things (IoT) device such as a sensor.

The base station in the present disclosure may be replaced with user terminal. For example, each aspect/embodiment of the present disclosure may be applied to a configuration in which communication between a base station and user terminal is replaced with communication between a plurality of pieces of user terminal (e.g., which may be referred to as device-to-device (D2D), vehicle-to-everything (V2X), and the like). In this case, the user terminal 20 may have the function of the base station 10 described above. The wording such as “up” and “down” may be replaced with the wording corresponding to communication between terminals (e.g., “side”). For example, an uplink channel and a downlink channel may be replaced with a side channel.

Similarly, the user terminal in the present disclosure may be replaced with a base station. In this case, the base station 10 may have the function of the user terminal 20 described above.

The operation that has been performed by a base station in the present disclosure may be performed by an upper node thereof in some cases. In a network including one or a plurality of network nodes with a base station, it is clear that various operations that are performed for communication with a terminal can be performed by a base station, one or more network nodes (e.g., mobility management entity (MME) and serving-gateway (S-GW) may be possible, but are not limitations) other than a base station, or a combination thereof.

Each aspect/embodiment illustrated in the present disclosure may be used individually or in a combination, and may be switched along with execution. The order of processing procedures, sequences, flowcharts, and the like of each aspect/embodiment described in the present disclosure may be changed as long as there is no inconsistence. For example, regarding the method described in the present disclosure, various step elements are presented by using an illustrative order, but the presented specific order is not a limitation.

Each aspect/embodiment illustrated in the present disclosure may be applied to, for example, long term evolution (LTE), LTE-Advanced (LTE-A), LTE-Beyond (LTE-B), SUPER 3G, IMT-Advanced, 4th generation mobile communication system (4G), 5th generation mobile communication system (5G), future radio access (FRA), new radio access technology (New-RAT), new radio (NR), new radio access (NX), future generation radio access (FX), global system for mobile communications (GSM) (registered trademark), CDMA 2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), systems using another appropriate radio communication method, and next generation systems expanded based on these systems. A plurality of systems may be combined (e.g., combination of LTE or LTE-A and 5G) and applied.

The description “based on” used in the present disclosure does not mean “based only on”, unless otherwise specified. In other words, the description “based on” means both “based only on” and “based at least on.”

Any reference to elements with designations such as “first”, “second”, and the like used in the present disclosure does not generally limit an amount or order of these elements. These designations may be used in the present disclosure as a convenient method of distinguishing two or more elements. Reference to the first and second elements does not mean that only two elements may be employed, or that the first element must precede the second element in some way.

The term “judging (determining)” used in the present disclosure may encompass a wide variety of operations. For example, “judging (determining)” may be regarded as “judging (determining)” judging, calculating, computing, processing, deriving, investigating, looking up, search, inquiry (e.g., looking up in a table, database, or another data structure), ascertaining, and the like.

“Judging (determining)” may be regarded as “judging (determining)” receiving (e.g., receiving information), transmitting (e.g., transmitting information), input, output, accessing (e.g., accessing data in a memory), and the like.

“Judging (determining)” may be regarded as “judging (determining)” resolving, selecting, choosing, establishing, comparing, and the like. That is, “judging (determining)” may be regarded to “judging (determining)” some operations.

“Judging (determining)” may be replaced with “assuming”, “expecting”, “considering”, and the like.

The terms “connected” and “coupled” used in the present disclosure, or all variations of these terms mean all direct or indirect connections or couplings between two or more elements, and can include the presence of one or more intermediate elements between two elements that are “connected” or “coupled” to each other. Elements may be coupled or connected physically, logically, or in a combination of physical and logical manners. For example, “connection” may be replaced with “access”.

In the present disclosure, when two elements are connected, these elements can be considered to be “connected” or “coupled” to each other by using one or more electrical wires, cables, printed electrical connections, and the like, and, in some non-limiting and non-inclusive examples, by using, for example, electromagnetic energy having wavelengths in the radio frequency domain, microwave regions, and (both visible and invisible) optical regions.

In the present disclosure, the phrase “A and B are different” may mean “A and B are different from each other”. Note that the phrase may mean that “each of A and B is different from C”. The terms such as “detached” and “coupled” may be interpreted similarly to “different”.

When the terms such as “include” and “including” and variations thereof are used in the present disclosure, these terms are intended to be inclusive similarly to the term “comprising”. The term “or” used in the present disclosure is intended not to be an exclusive-OR.

In the present disclosure, for example, when an article such as “a”, “an”, and “the” in English is added in translation, the present disclosure may include the fact that a noun following these articles may be nouns of plural forms.

Although the invention according to the present disclosure has been described in detail above, it is obvious to a person skilled in the art that the invention according to the present disclosure is not limited to the embodiments described in the present disclosure. The invention according to the present disclosure can be implemented as a correction and a modification without departing from the spirit and scope of the invention defined by the recitations of claims. Consequently, the present disclosure is described for the purpose of exemplification and explanation, and has no limitative meaning to the invention according to the present disclosure.

1. A user terminal comprising:
a control section that, when a plurality of uplink channels is transmitted in an overlapping period, determines an uplink channel to be transmitted among the plurality of uplink channels based on information regarding quasi-co-location (QCL) of each of the plurality of uplink channels; and
a transmitting section that transmits the determined uplink channel in the period.

2. The user terminal according to claim 1, wherein, when pieces of information regarding the QCL of the plurality of uplink channels are different, the control section determines a channel having a longest or shortest duration among the plurality of uplink channels as an uplink channel to be transmitted.

3. The user terminal according to claim 1, wherein, when a number of the plurality of uplink channels is more than two, and the plurality of uplink channels includes a set of first uplink channels having a relation of QCL type D with each other and a set of second uplink channels having a relation of QCL type D with each other, the control section determines an uplink channel included in a set having a larger number of channels as an uplink channel to be transmitted.

4. The user terminal according to claim 1, wherein, when the plurality of uplink channels is larger in number than the maximum number of beams capable of being simultaneously transmitted, the control section determines an uplink channel to be transmitted among the plurality of uplink channels based on information regarding the QCL of the plurality of uplink channels.

5. A radio communication method for a user terminal comprising:
when a plurality of uplink channels is transmitted in an overlapping period, determining an uplink channel to be transmitted among the plurality of uplink channels based on information regarding quasi-co-location (QCL) of each of the plurality of uplink channels; and
transmitting the determined uplink channel in the period.

6. The user terminal according to claim 2, wherein, when a number of the plurality of uplink channels is more than two, and the plurality of uplink channels includes a set of first uplink channels having a relation of QCL type D with each other and a set of second uplink channels having a relation of QCL type D with each other, the control section determines an uplink channel included in a set having a larger number of channels as an uplink channel to be transmitted.

7. The user terminal according to claim 2, wherein, when the plurality of uplink channels is larger in number than the maximum number of beams capable of being simultaneously transmitted, the control section determines an uplink channel to be transmitted among the plurality of uplink channels based on information regarding the QCL of the plurality of uplink channels.

8. The user terminal according to claim 3, wherein, when the plurality of uplink channels is larger in number than the maximum number of beams capable of being simultaneously transmitted, the control section determines an uplink channel to be transmitted among the plurality of uplink channels based on information regarding the QCL of the plurality of uplink channels.
